(19) United States
(12) Patent Application Publication
(10) Pub. No.: US 2026/0356206 A1
(43) Pub. Date: Nov. 12, 2026

(54) ELECTRIFIED VEHICLE AND A CONTROL METHOD THEREOF

(71) Applicants: HYUNDAI MOTOR COMPANY, Seoul (KR); KIA CORPORATION, Seoul (KR)

(72) Inventors: Dong Hoon Jeong, Hwaseong-si (KR); Kyoung Soo We, Hwaseong-si (KR)

(73) Assignees: HYUNDAI MOTOR COMPANY, Seoul (KR); KIA CORPORATION, Seoul (KR)

(21) Appl. No.: 19/368,884

(22) Filed: Oct. 24, 2025

(30) Foreign Application Priority Data
May 12, 2025 (KR) 10-2025-0061400

(51) Int. Cl. B60L 15/20

(52) U.S. Cl. CPC B60L 15/20; B60L 2240/12; B60L 2240/16; B60L 2240/423; B60L 2250/28; B60L 2260/24

(57) ABSTRACT

An electrified vehicle includes a controller configured to determine a required vehicle speed corresponding to accelerator pedal sensing information. The controller is also configured to determine a target vehicle speed to reach the required vehicle speed based on a vehicle speed. The controller is additionally configured to determine a variation of the target vehicle speed based on the required vehicle speed and the target vehicle speed. The controller is configured to control a torque of a drive motor such that the vehicle speed follows a target vehicle speed taking the variation into account.

### CROSS REFERENCE TO RELATED APPLICATION

The present application claims the benefit of and priority to Korean Patent Application No. 10-2025-0061400, filed on May 12, 2025, the entire contents of which are hereby incorporated herein by reference.

### TECHNICAL FIELD

The present disclosure relates to an electrified vehicle and a control method of the electrified vehicle.

### BACKGROUND

Taking into account the structure of an internal combustion engine in which torque is controlled based on the amount of opening of a throttle valve linked to an accelerator pedal, a table that determines the required torque relationship of a power source based on accelerator pedal input is referred to as a torque-based pedal map or torque map. A vehicle to which the torque-based pedal map is applied may control drive torque to follow required torque determined based on the pedal map.

When the torque-based pedal map is applied to an electrified vehicle, a vehicle speed may vary depending on environmental factors such as vehicle weight and driving resistance even at the same torque, and continuous operation of the accelerator pedal may be required to maintain a desired speed. In addition, a drive motor of the electrified vehicle responds to torque more quickly than in an internal combustion engine vehicle, and thus acceleration and deceleration characteristics resulting from accelerator pedal operation may differ from the characteristics of the internal combustion engine vehicle.

The matters described in this Background section are provided solely to facilitate a better understanding of the background of the present disclosure and should not be construed as an admission that the matters constitute a related art already known to those having ordinary skill in the art.

### SUMMARY

Embodiments of the present disclosure provide an electrified vehicle and a control method thereof, that perform vehicle speed control based on a required vehicle speed corresponding to accelerator pedal operation.

Embodiments of the present disclosure provide an electrified vehicle and a control method thereof, that may reduce a vehicle speed variation caused by the influence of environmental factors such as a gradient change in a driving road, vehicle weight, and driving resistance, as compared to the torque map-based control.

Technical objectives of the present disclosure are not limited to the technical objectives mentioned above. Other technical objectives not mentioned herein should be more clearly understood by those having ordinary skill in the art to which the present disclosure pertains from the following description.

According to an embodiment of the present disclosure, an electrified vehicle is provided. The electrified vehicle includes a controller configured to determine a required vehicle speed corresponding to accelerator pedal sensing information. The controller is also configured to determine a target vehicle speed to reach the required vehicle speed based on the vehicle speed of the electrified vehicle. The controller is further configured to determine a variation of the target vehicle speed based on the required vehicle speed and the target vehicle speed. The controller is further configured to control a torque of a drive motor such that the vehicle speed follows a target vehicle speed taking the variation into account.

According to an embodiment, the required vehicle speed may be determined further based on the vehicle speed.

According to an embodiment, the required vehicle speed may be determined based on a required vehicle speed map in which the required vehicle speed corresponding to the accelerator pedal sensing information is predefined as a function of the vehicle speed.

According to an embodiment, the required vehicle speed map may be set such that the required vehicle speed varies to converge toward a preset constant-speed-maintaining vehicle speed in response to the accelerator pedal sensing information.

According to an embodiment, the target vehicle speed variation may be determined based on a target vehicle speed variation map in which the required vehicle speed and the target vehicle speed variation corresponding to a difference between the required vehicle speed and the target vehicle speed are preset.

According to an embodiment, the target vehicle speed variation map may be set such that the target vehicle speed variation is proportional to a value obtained by subtracting the target vehicle speed from the required vehicle speed.

According to an embodiment, the controller may be configured to determine an initial value of the target vehicle speed based on the vehicle speed, determine a sum of the variation and the target vehicle speed, and update the target vehicle speed based on the sum of the variation and the target vehicle speed.

According to an embodiment, the controller may be configured to determine a target torque based on the target vehicle speed variation corresponding to the required vehicle speed, road gradient information, and driving resistance information. The controller may be configured to control the torque of the drive motor to follow the target torque.

According to an embodiment, the controller may be configured to control the torque of the drive motor based on a coasting mode that causes the electrified vehicle to coast, based on a determination that a pedal value, is less than or equal to a preset lower limit value, where the pedal value corresponds to a degree of operation of an accelerator pedal determined based on the accelerator pedal sensing information.

According to an embodiment, the electrified vehicle may further include an interface unit configured to receive input on whether to use a coasting mode that causes the electrified vehicle to coast.

According to another embodiment of the present disclosure, a control method of an electrified vehicle is provided. The control method includes determining, by a controller, a required vehicle speed corresponding to accelerator pedal sensing information. The control method also includes determining, by the controller, a target vehicle speed to reach the required vehicle speed based on a vehicle speed of the electrified vehicle. The control method additionally includes determining, by the controller, a variation of the target vehicle speed based on the required vehicle speed and the target vehicle speed. The method further includes controlling, by the controller, a torque of a drive motor such that the vehicle speed follows a target vehicle speed taking the variation into account.

According to an embodiment, determining the required vehicle speed may include determining the required vehicle speed further based on the vehicle speed.

According to an embodiment, determining the required vehicle speed may include be determining the required vehicle speed based on a required vehicle speed map in which the required vehicle speed corresponding to the accelerator pedal sensing information and the vehicle speed is preset as a function of the vehicle speed.

According to an embodiment, the required vehicle speed map may be set such that the required vehicle speed varies to converge toward a preset constant-speed-maintaining vehicle speed in response to the accelerator pedal sensing information.

According to an embodiment, determining the target vehicle speed variation includes determining target vehicle speed variation based on a target vehicle speed variation map in which the required vehicle speed and the target vehicle speed variation corresponding to a difference between the required vehicle speed and the target vehicle speed are preset.

According to an embodiment, the target vehicle speed variation map may be set such that the target vehicle speed variation is proportional to a value obtained by subtracting the target vehicle speed from the required vehicle speed.

According to an embodiment, the control method may further include determining, by the controller, an initial value of the target vehicle speed based on the vehicle speed. The control method may also include updating the target vehicle speed based on a sum of the variation and the target vehicle speed variation.

According to an embodiment, controlling the torque of the drive motor includes determining target torque based on the target vehicle speed variation corresponding to the required vehicle speed, road gradient information, and driving resistance information, and controlling the torque of the drive motor to follow the target torque.

According to an embodiment, the control method may further include controlling, by the controller, the torque of the drive motor based on a coasting mode that causes the electrified vehicle to coast, based on a determination that a pedal value is less than or equal to a preset lower limit value, where the pedal value corresponds to a degree of operation of an accelerator pedal determined based on the accelerator pedal sensing information.

According to an embodiment, the control method may further include receiving, by an interface unit, input on whether to use a coasting mode that causes the electrified vehicle to coast.

Embodiments of the present disclosure provide an electrified vehicle and a control method thereof, that perform vehicle speed control based on a required vehicle speed corresponding to accelerator pedal operation.

Embodiments of the present disclosure provide an electrified vehicle and a control method thereof, that may reduce a vehicle speed variation caused by the influence of environmental factors such as vehicle weight and driving resistance.

The effects that may be achieved from the present disclosure are not limited to the effects mentioned above. Other effects not mentioned herein should be more clearly understood by those having ordinary skill in the art to which the present disclosure pertains from the following description.

### BRIEF DESCRIPTION OF THE DRAWINGS

FIGS. 1 and 2 are views illustrating an electrified vehicle according to an embodiment.

FIG. 3 is a view illustrating a required vehicle speed map in a vehicle speed-based control mode according to an embodiment.

FIG. 4 is a view illustrating a target vehicle speed variation map in the vehicle speed-based control mode according to an embodiment.

FIG. 5 is a view illustrating a required vehicle speed, a target vehicle speed, and a vehicle speed in response to accelerator pedal operation in the vehicle speed-based control mode according to an embodiment.

FIGS. 6-9 are graphs illustrating a vehicle speed and torque of a drive motor corresponding to a pedal value in the vehicle speed-based control mode according to an embodiment.

FIG. 10 is a flowchart illustrating a case in which a coasting mode is selected according to an embodiment.

FIG. 11 is a flowchart illustrating a control method of the electrified vehicle according to an embodiment.

### DETAILED DESCRIPTION

In the following description, where it was determined that a detailed description of a known features or functions would obscure the gist of the present disclosure, the detailed description thereof has been omitted herein. In addition, the accompanying drawings are provided merely to enhance understanding of the embodiments disclosed herein, and the technical spirit of the present disclosure is not limited by the accompanying drawings. Rather, it should be understood that the present disclosure includes all modifications, equivalents, and substitutes included in the spirit and technical scope of the present disclosure. The following description is not intended to limit the present disclosure to the described form or a specific field. It should be understood that various alternative aspects and variations of the present disclosure are possible, whether explicitly stated or implied herein. Those having ordinary skill in the art to which the present disclosure pertains should recognize that the form and details of the subject matter disclosed herein may be modified.

The present disclosure is described with reference to certain aspects. However, as should be understood by those having ordinary skill in the art to which the present disclosure pertains, the various aspects described herein may be modified or otherwise implemented in various different ways without departing from the spirit and scope of the present disclosure. Accordingly, the following description should be considered illustrative and is provided to enable those having ordinary skill in the art to which the present disclosure pertains to develop and use various embodiments. It should be understood that the forms of the present disclosure illustrated and described herein should be taken as example embodiments. Equivalent elements, materials, processes, steps, etc. may be substitute those illustrated and described in the present disclosure. As used in the present disclosure, expressions such as “including,” “comprising,” “incorporating,” “consisting of,” “have,” “is,” and the like should be construed in a non-exclusive manner, i.e., to permit the inclusion of items, components, or elements not explicitly stated. In addition, references to the singular should be construed to include the plural.

In addition, the various embodiments described herein should be taken in an illustrative sense and should not be construed as limiting the scope of the present disclosure. Any references to joining (e.g., attached, affixed, coupled, connected, etc.) are used solely to facilitate better understanding of embodiments of the present disclosure and are not intended to limit the location, direction, or use of the components or the method disclosed herein. Accordingly, when references to joining are present, the references should be construed broadly. Furthermore, such references to joining do not necessarily imply that two or more elements are directly connected to each other. Additionally, any numerical terms, such as “first,” “second,” “third,” “primary,” “secondary,” “major,” or any other generic or numerical terms, should be taken as identifiers solely to facilitate better understanding of the various components, forms, variations, or modifications of the embodiments of the present disclosure and do not imply any limitations to any component, form, variation, or modification or to any order or preference thereof. These expressions may be used to describe various components, but the components are not limited by such expressions. The expressions are used solely for the purpose of distinguishing one component from another component.

As used in the following description, suffixes “module” and “part” for a component are used or interchangeably used solely for ease of explanation. The suffixes do not, in themselves, have meanings or functions that are distinct from one another.

When a component is referred to as being “connected” or “coupled” to another component, the component may be directly connected or coupled to the other component, but it should be understood that one or more additional components may be present between the component and the other component. Conversely, when a component is referred to as being “directly connected” or “directly coupled” to another component, it should be understood that no further component is present between the component and the other component.

In addition, a unit or control unit included in names is merely a term widely used in the naming of a controller that controls the certain function of a vehicle, but does not mean a generic function unit.

A controller may include a communication device for communicating with other control units or sensors to control a particular function, a memory for storing an operating system, a logic command, and input/output information, and at least one processor for executing determination, calculation, and decision which are necessary for controlling the particular function.

Any number of components or a variety of components in any of the configurations described herein may be included in embodiments of the present disclosure. The components may include any combination of the features described herein, and may be arranged in any of the various configurations described herein. The concepts associated with the structure and arrangement of components, as well as their use and operation, of the present disclosure may be applied not only to certain embodiments described herein but also to any number and combination of embodiments. Embodiments including those having various features of various arrangements are described below with reference to the accompanying drawings.

When a component, controller, device, element, unit, apparatus, or the like of the present disclosure is described as having a purpose or performing an operation, function, or the like, the component, controller, device, element, unit, apparatus, or the like should be considered herein as being “configured to” meet that purpose or to perform that operation or function. Each component, controller, device, element, unit, apparatus, and the like may separately embody or be included with a processor and a memory, such as a non-transitory computer readable media, as part of the apparatus.

Hereinafter, various embodiments of the present disclosure are described in detail with reference to the accompanying drawings. The same reference numerals are given to the same or similar components regardless of reference numerals of the drawings, and a repetitive description thereof has been omitted.

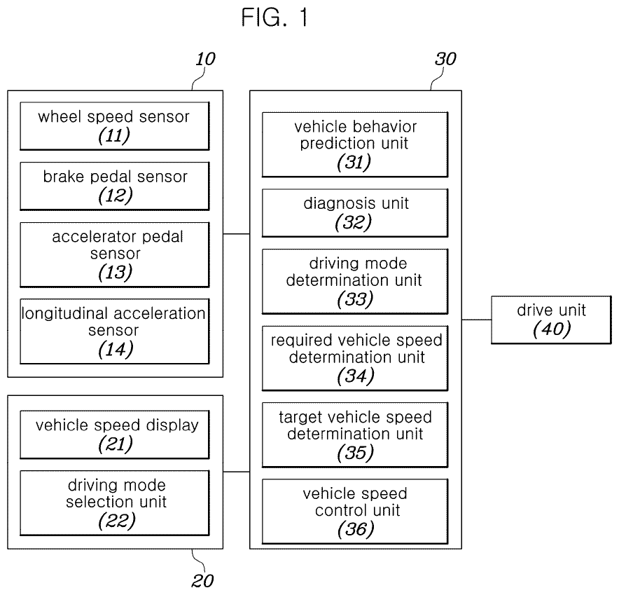

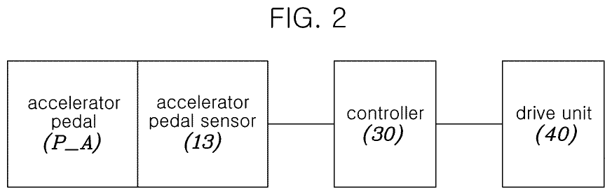

FIGS. 1 and 2 are views illustrating an electrified vehicle according to an embodiment.

Referring to FIGS. 1 and 2, an electrified vehicle may include a sensor unit 10 including an accelerator pedal P_A, a wheel speed sensor 11, a brake pedal sensor 12, an accelerator pedal sensor 13, a longitudinal acceleration sensor 14. The electrified vehicle may also include an interface unit 20 including a vehicle speed display 21 and a driving mode selection unit 22. The electrified vehicle may further include a controller 30 including a vehicle behavior prediction unit 31, a diagnosis unit 32, a driving mode determination unit 33, a required vehicle speed determination unit 34, a target vehicle speed determination unit 35, and a vehicle speed control unit 36. The electrified vehicle may additionally include a drive unit 40.

The sensor unit 10 may collect information from the wheel speed sensor 11, the brake pedal sensor 12, the accelerator pedal sensor 13, the longitudinal acceleration sensor 14, or the like, and may transmit the collected information to the interface unit 20 and/or the controller 30. The interface unit 20 and/or the controller 30 may thus obtain one or more of i) information on a rotational speed at which a wheel (not illustrated) of the electrified vehicle rotates from the wheel speed sensor 11, ii) information on operation of a brake pedal (not illustrated) from the brake pedal sensor 12, iii) information on accelerator pedal sensing corresponding to the degree of operation of the accelerator pedal P_A from the accelerator pedal sensor 13, or iv) information on longitudinal acceleration of the electrified vehicle from the longitudinal acceleration sensor 14. However, the types of sensors and the types of information obtained from the sensors described above are illustrative, and the types of sensors that may be included in the electrified vehicle and the types of information obtained from the sensors are not limited to the types of sensors and information described above.

The interface unit 20 may be a component corresponding to a Human-Machine Interface (HMI). The interface unit 20 may include an Audio, Video, Navigation, Telescope (AVNT) terminal, a cluster unit, or the like, that may output the status of the electrified vehicle or receive a user's request.

The vehicle speed display 21 may output the current vehicle speed of the electrified vehicle, the required vehicle speed corresponding to the accelerator pedal sensing information, or the like. In an example, in a drive mode that allows a user to adjust preset values of a drivetrain or the like, the vehicle speed display 21 may be configured to display, on a screen, a speed, which may be more familiar to the user, instead of torque and acceleration, which may be difficult for the user to intuitively understand. As used herein, a “vehicle speed” (also sometimes referred to herein as “actual vehicle speed” or “real vehicle speed”) may correspond to i) an actual vehicle speed of the electrified vehicle when the vehicle speed control unit 36 controls torque of the drive unit 40 to follow a target vehicle speed or ii) the current vehicle speed of the electrified vehicle obtained through the sensor unit 10.

The driving mode selection unit 22 may receive a request to use a vehicle speed-based control mode that i) determines a required vehicle speed based on a required vehicle speed map indicating a required vehicle speed corresponding to the accelerator pedal sensing information and ii) controls the vehicle speed of the electrified vehicle to follow the determined required vehicle speed. As another example, the interface unit 20 may receive a request to use a torque-based control mode that i) determines required torque based on a torque map indicating required torque corresponding to the accelerator pedal sensing information and ii) causes drive torque to follow the determined required torque. As yet another example, the interface unit 20 may receive a request to use a coasting mode that causes the electrified vehicle to coast.

The controller 30 may determine a required vehicle speed corresponding to the degree of operation of the accelerator pedal P_A and the vehicle speed of the electrified vehicle, based on the accelerator pedal sensing information received from the accelerator pedal sensor 13. The controller 30 may also determine a target vehicle speed based on the required vehicle speed and the vehicle speed of the electrified vehicle. The controller 30 may control the drive unit 40 or the like such that the vehicle speed of the electrified vehicle follows the target vehicle speed corresponding to the accelerator pedal sensing information. As used herein, the control target vehicle speed or the target vehicle speed may mean a reference vehicle speed for speed follow-up control, such that the vehicle speed of the electrified vehicle converges to the required speed.

The vehicle behavior prediction unit 31 may determine information necessary for a collision avoidance function of the vehicle or the like based on the obtained information. For example, the vehicle behavior prediction unit 31 may determine a state variable value for performing a collision avoidance function of the vehicle based on the obtained information. The vehicle behavior prediction unit 31 may output guidance corresponding to the collision avoidance function of the vehicle to the interface unit 20 and/or may provide collision avoidance vehicle speed information corresponding to the collision avoidance function of the vehicle to the vehicle speed control unit 36.

The diagnosis unit 32 may determine, based on the obtained information, whether abnormality is present in the drive motor, a pedal, a controller area network (CAN), a vehicle speed, or the like. For example, the diagnosis unit 32 may diagnose whether sensors such as the wheel speed sensor 11, the brake pedal sensor 12, the accelerator pedal sensor 13, and/or the longitudinal acceleration sensor 14 operate normally. Based on determining that abnormality is present, the diagnosis unit 32 may transmit, to the interface unit 20, a request message to output a warning.

The driving mode determination unit 33 may determine a driving mode of the electrified vehicle currently in use, and may transmit a request message to perform control corresponding to the determined driving mode. For example, if the driving mode determination unit 33 determines that the vehicle speed-based control mode is to be used, the driving mode determination unit 33 may transmit, to the vehicle speed determination unit 34, the target vehicle speed determination unit 35, and the vehicle speed control unit 36, a command to perform the vehicle speed-based control mode.

The required vehicle speed determination unit 34 may determine a required vehicle speed corresponding to the accelerator pedal sensing information based on the accelerator pedal sensing information and the vehicle speed. For example, the required vehicle speed determination unit 34 may determine a required vehicle speed based on a preset required vehicle speed map. In an embodiment, the required vehicle speed map may be a map in which a required vehicle speed corresponding to the accelerator pedal sensing information is predefined for a plurality of vehicle speeds. In addition, the preset required vehicle speed map may be designed to allow the user to change the vehicle speed setting corresponding to an amount of accelerator pedal operation through the interface unit 20.

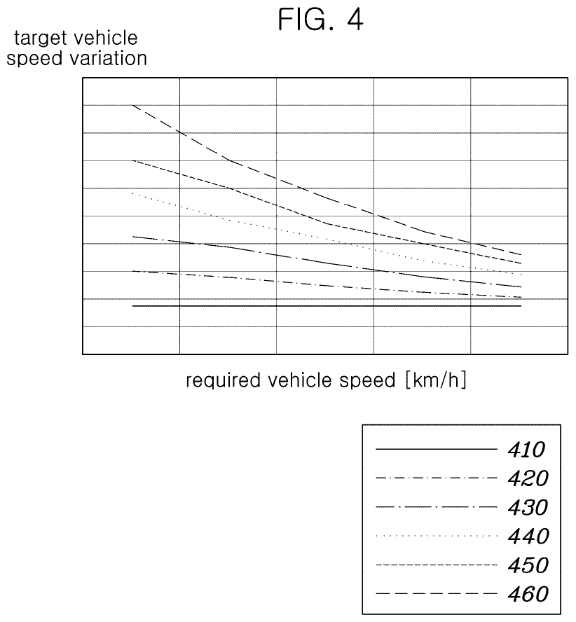

The target vehicle speed determination unit 35 may determine a target vehicle speed. The target vehicle speed may be a control target for reaching the required vehicle speed. The target vehicle speed may be determined based on the vehicle speed. Further, a variation of the target vehicle speed may be determined based on the determined target vehicle speed and the required vehicle speed determined by the required vehicle speed determination unit 34. In an embodiment, the target vehicle speed determination unit 35 may determine the target vehicle speed based on a target vehicle speed variation map. The target vehicle speed variation map may be a map in which i) a target vehicle speed and a required vehicle speed corresponding to the current vehicle speed of the electrified vehicle and ii) a target vehicle speed variation corresponding to a value obtained by subtracting the target vehicle speed from the required vehicle speed are predefined. For example, the target vehicle speed determination unit 35 may determine an initial value of the target vehicle speed based on the vehicle speed of the electrified vehicle. The target vehicle speed determination unit 35 may also determine the target vehicle speed variation, based on the required vehicle speed and the value obtained by subtracting the target vehicle speed from the required vehicle speed, based on a preset target vehicle speed variation map. The target vehicle speed determination unit 35 may then update the target vehicle speed as the sum of the target vehicle speed and the target vehicle speed variation. The preset target vehicle speed variation map, according to an embodiment, is described in more detail below with reference to FIG. 4.

The vehicle speed control unit 36 may control the drive unit 40 or the like, such that the vehicle speed of the electrified vehicle converges to a required vehicle speed corresponding to the accelerator pedal sensing information. For example, the vehicle speed control unit 36 may control the drive unit 40 or the like to follow the target vehicle speed corresponding to the accelerator pedal sensing information, such that the vehicle speed of the electrified vehicle converges to the required vehicle speed corresponding to the accelerator pedal sensing information and the vehicle speed. In addition, the vehicle speed control unit 36 may determine target torque based on a variation of the target vehicle speed corresponding to the required vehicle speed and the target vehicle speed, road gradient information, and driving resistance information, and may control the torque of the drive motor (not illustrated) to follow the target torque corresponding to the required vehicle speed. For example, the vehicle speed control unit 36 may control the torque of the drive motor (not illustrated) to follow the target torque corresponding to the required vehicle speed based on Equation 1 below. In Equation 1, m may represent the weight of the electrified vehicle, v may represent the target vehicle speed, Ft may represent the target torque for following the target vehicle speed, FR may represent the driving resistance, and 0 may represent the road gradient.

$$m \frac{d}{d t} v = {F}_{t} - {F}_{R} - m g sin θ \qquad [ Equation 1 ]$$

The drive unit 40 may include the drive motor (not illustrated) configured to provide driving power to the electrified vehicle and an inverter (not illustrated) configured to apply electric power to the drive motor (not illustrated).

Referring again to FIG. 2, in the vehicle speed-based control mode, the accelerator pedal sensor 13 attached to the accelerator pedal P_A may transmit, to the controller 30, the accelerator pedal sensing information corresponding to the degree of operation of the accelerator pedal P_A. The controller 30 may calculate a required vehicle speed corresponding to the accelerator pedal sensing information and may control the drive unit 40 such that the vehicle speed converges to the required vehicle speed. Hereinafter, the degree of operation of the accelerator pedal determined based on the accelerator pedal sensing information is referred to as a pedal value.

In an embodiment, the controller 30 may perform control, such that the vehicle speed converges to the required vehicle speed corresponding to the accelerator pedal sensing information and the vehicle speed, based on a preset target vehicle speed map and the preset target vehicle speed variation map.

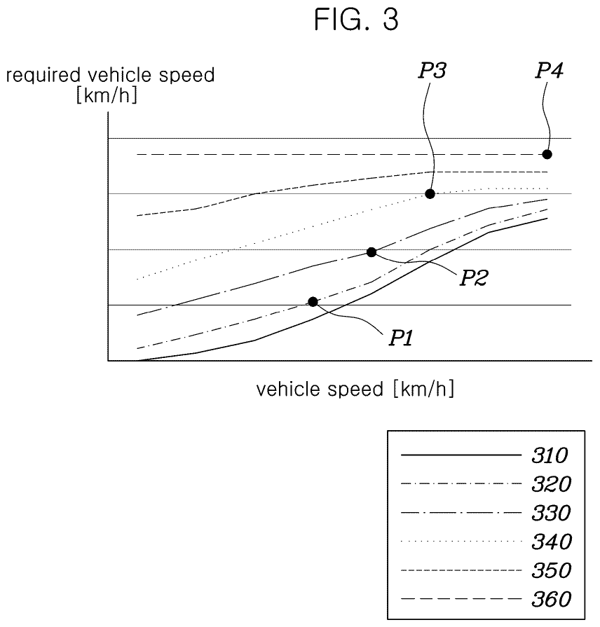

The preset required vehicle speed map and the preset target vehicle speed variation map in the vehicle speed-based control mode, according to embodiments, are described in more detail below with reference to FIGS. 3 and 4

FIG. 3 is a view illustrating a required vehicle speed map in a vehicle speed-based control mode according to an embodiment.

Referring to FIG. 3, a first required vehicle speed graph 310 illustrates a required vehicle speed corresponding to a first pedal value and a vehicle speed. A second required vehicle speed graph 320 illustrates a required vehicle speed corresponding to a second pedal value greater than the first pedal value and a vehicle speed. A third required vehicle speed graph 330 illustrates a required vehicle speed corresponding to a third pedal value, greater than the second pedal value, and a vehicle speed. A fourth required vehicle speed graph 340 illustrates a required vehicle speed corresponding to a fourth pedal value, greater than the third pedal value, and a vehicle speed. A fifth required vehicle speed graph 350 illustrates a required vehicle speed corresponding to a fifth pedal value, greater than the fourth pedal value, and a vehicle speed. A sixth required vehicle speed graph 360 illustrates a required vehicle speed corresponding to a sixth pedal value, that is greater than the fifth pedal value and is an upper limit pedal value, and a vehicle speed. FIG. 3 also shows a first constant-speed-maintaining vehicle speed P1 corresponding to the second pedal value, a second constant-speed-maintaining vehicle speed P2 corresponding to the third pedal value, a third constant-speed-maintaining vehicle speed P3 corresponding to the fourth pedal value, and a fourth constant-speed-maintaining vehicle speed P4 corresponding to the sixth pedal value.

The required vehicle speed may be determined based on the required vehicle speed map in which a relationship between the required vehicle speed corresponding to the accelerator pedal sensing information and the vehicle speed of the electrified vehicle is preset.

The required vehicle speed map may be set such that the required vehicle speed varies to converge toward a preset constant-speed-maintaining vehicle speed in response to the accelerator pedal sensing information. In other words, the required vehicle speed map may be set such that the required vehicle speed varies until the required vehicle speed reaches the preset constant-speed-maintaining vehicle speed in response to the pedal value.

For example, referring to the second required vehicle speed graph 320, that assumes that the second pedal value is maintained, the required vehicle speed map may be set based on the first constant-speed-maintaining vehicle speed P1. The first constant-speed-maintaining vehicle speed P1 may be a point at which the required vehicle speed is equal to the constant-speed-maintaining vehicle speed. The required vehicle speed map may be set such that i) the slope of the required vehicle speed corresponding to the vehicle speed is greater than 1 in a range where the vehicle speed is less than the first constant-speed-maintaining vehicle speed P1 and ii) the slope of the required vehicle speed corresponding to the vehicle speed is less than 1 in a range where the vehicle speed is greater than the first constant-speed-maintaining vehicle speed P1.

As another example, referring to the sixth required vehicle speed graph 360 corresponding to the sixth pedal value, that is the upper limit of the pedal value, the required vehicle speed map may be set such that if the pedal value corresponds to the preset upper limit, the required vehicle speed corresponds to the fourth constant-speed-maintaining vehicle speed P4 corresponding to the sixth pedal value, regardless of the vehicle speed.

However, the required vehicle speed map described above is illustrative, and the present disclosure is not limited thereto. For example, the required vehicle speed map does not necessarily need to be set by considering both the accelerator pedal sensing information and the vehicle speed. As an example, the required vehicle speed map may be set such that the required vehicle speed corresponds to a preset constant-speed-maintaining vehicle speed in response to the accelerator pedal sensing information, regardless of the current vehicle speed. As another example, the required vehicle speed map may be set such that the required vehicle speed corresponds to a preset constant-speed-maintaining vehicle speed in response to the accelerator pedal sensing information.

FIG. 4 is a view illustrating a target vehicle speed variation map in the vehicle speed-based control mode according to an embodiment.

FIG. 4 shows an example in which the required vehicle speed is greater than the target vehicle speed. Referring to FIG. 4, a first variation graph 410 illustrates the variation of the target vehicle speed corresponding to the required vehicle speed, if a difference between the required vehicle speed and the target vehicle speed is a first difference value that is within a predetermined difference value. A second variation graph 420 illustrates the variation of the target vehicle speed corresponding to the required vehicle speed, if a difference between the required vehicle speed and the target vehicle speed is a second difference value greater than the first difference value. A third variation graph 430 illustrates the variation of the target vehicle speed corresponding to the required vehicle speed, if a difference between the required vehicle speed and the target vehicle speed is a third difference value greater than the second difference value. A fourth variation graph 440 illustrates the variation of the target vehicle speed corresponding to the required vehicle speed, if a difference between the required vehicle speed and the target vehicle speed is a fourth difference value greater than the third difference value. A fifth variation graph 450 illustrates the variation of the target vehicle speed corresponding to the required vehicle speed, if a difference between the required vehicle speed and the target vehicle speed is a fifth difference value greater than the fourth difference value. A sixth variation graph 460 illustrates the variation of the target vehicle speed corresponding to the required vehicle speed, if a difference between the required vehicle speed and the target vehicle speed is a sixth difference value greater than the fifth difference value.

The target vehicle speed variation may be determined based on the target vehicle speed variation map in which a relationships between the required vehicle speed and the target vehicle speed variation corresponding to the difference between the required vehicle speed and the target vehicle speed are preset.

The target vehicle speed variation map may be set such that the target vehicle speed variation is proportional to the difference between the magnitude of the required vehicle speed and the target vehicle speed. For example, referring to the first variation graph 410 and the second variation graph 420, the target vehicle speed variation map may be set such that the variation of the target vehicle speed corresponding to the same required vehicle speed is greater when the difference between the required vehicle speed and the target vehicle speed is a second difference value greater than a first difference value than when the difference between the required vehicle speed and the target vehicle speed is the first difference value.

As another example, if the difference between the required vehicle speed and the target vehicle speed remains constant, the target vehicle speed variation map may be set such that the variation of the required vehicle speed is inversely proportional to the target vehicle speed variation. For example, referring to the sixth variation graph 460, the target vehicle speed variation map may be set such that the variation of the target vehicle speed corresponding to a sixth difference value and the required vehicle speed is relatively larger in a range where the required vehicle speed is low, and the variation of the target vehicle speed corresponding to the sixth difference value and the required vehicle speed is relatively smaller in a range where the required vehicle speed is high.

In addition, although FIG. 4 is described assuming a situation where the required vehicle speed is greater than the target vehicle speed, the variation of the target vehicle speed corresponding to the difference value between the required vehicle speed and the target vehicle speed, as well as the required vehicle speed, may similarly be observed when the required vehicle speed is less than the target vehicle speed.

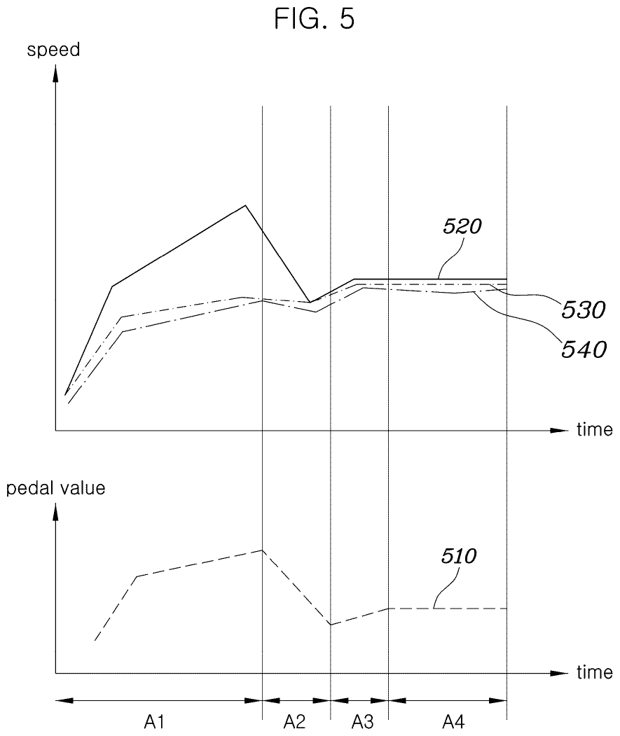

The vehicle speed, torque, or the like corresponding to the operation of the accelerator pedal in the vehicle speed-based control mode, according to embodiments, is described in more detail below with reference to FIGS. 5-9.

FIG. 5 is a view illustrating a required vehicle speed, a target vehicle speed, and a vehicle speed in response to accelerator pedal operation in the vehicle speed-based control mode according to an embodiment.

Referring to FIG. 5, according to an embodiment, an accelerator pedal value graph 510 illustrates the accelerator pedal value in response to the accelerator pedal operation. A required vehicle speed graph 520 illustrates the required vehicle speed corresponding to the accelerator pedal operation. A target vehicle speed graph 530 illustrates the target vehicle speed corresponding to the accelerator pedal operation. A vehicle speed graph 540 illustrates the vehicle speed corresponding to the accelerator pedal operation. FIG. 5 also shows a first range A1 and a third range A3 in which the pedal value increases, a second range A2 in which the pedal value decreases, and a fourth range A4 in which the pedal value is maintained.

Referring to the accelerator pedal value graph 510, the required vehicle speed graph 520, the target vehicle speed graph 530, and the vehicle speed graph 540 in the first range A1 and the third range A3 in which the pedal value increases, the required vehicle speed corresponding to the pedal value and vehicle speed may increase if the pedal value increases. In addition, if the required vehicle speed: increases, the target vehicle speed corresponding to the required vehicle speed may increase, and the vehicle speed may be controlled to follow the target vehicle speed, such that the vehicle speed may also increase.

Referring to the accelerator pedal value graph 510, the required vehicle speed graph 520, the target vehicle speed graph 530, and the vehicle speed graph 540 in the second range A2 in which the pedal value decreases, the required vehicle speed corresponding to the pedal value and the vehicle speed may also decrease if the pedal value decreases. In addition, the target vehicle speed corresponding to the required vehicle speed may also decrease, and the vehicle speed may be controlled to follow the target vehicle speed, such that the vehicle speed may also decrease.

Referring to the accelerator pedal value graph 510, the required vehicle speed graph 520, the target vehicle speed graph 530, and the vehicle speed graph 540 in the fourth range A4 in which the pedal value is maintained, the required vehicle speed may be maintained at the required vehicle speed corresponding to the pedal value and the vehicle speed, if the pedal value is maintained. In addition, if the pedal value is maintained, the target vehicle speed may converge to the required vehicle speed, and the vehicle speed may be controlled to follow the target vehicle speed, such that the vehicle speed may converge to the target vehicle speed and the required vehicle speed corresponding to the pedal value.

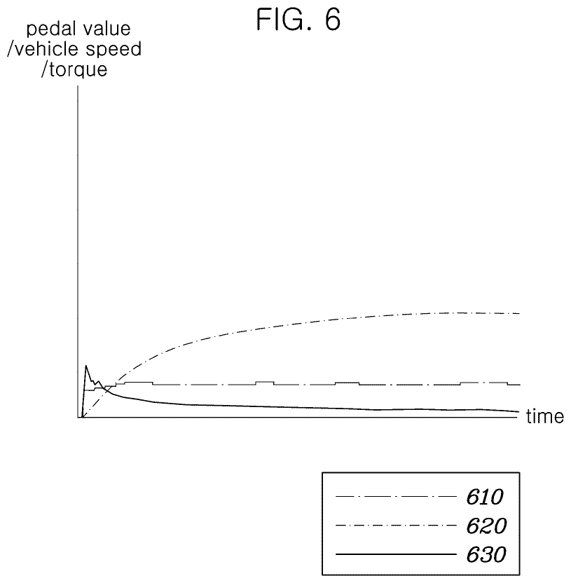

FIGS. 6-9 are graphs illustrating a vehicle speed and torque of a drive motor corresponding to a pedal value in the vehicle speed-based control mode according to an embodiment.

Referring to FIG. 6, a first pedal value graph 610 illustrates the pedal value when the pedal value is adjusted to a first value. a first vehicle speed graph 620 illustrates the vehicle speed when the pedal value is adjusted to the first value. A first torque graph 630 illustrates the torque when the pedal value is adjusted to the first value.

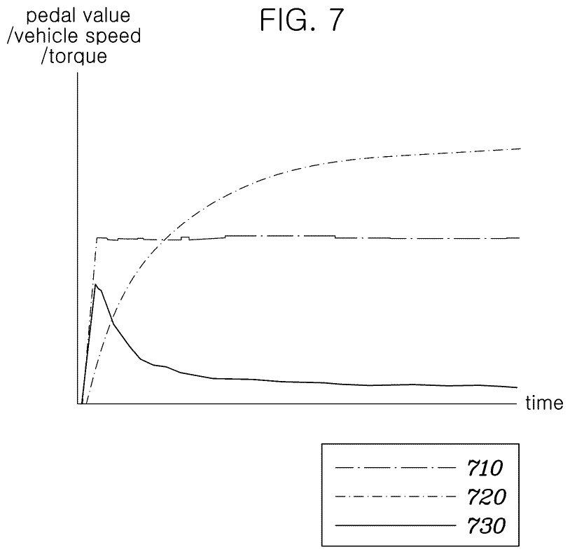

Referring to FIG. 7, a second pedal value graph 710 illustrates the pedal value when the pedal value is adjusted to a second value greater than the first value. A second vehicle speed graph 720 illustrates the vehicle speed when the pedal value is adjusted to the second value greater than the first value. A second torque graph 730 illustrates the torque when the pedal value is adjusted to the second value greater than the first value.

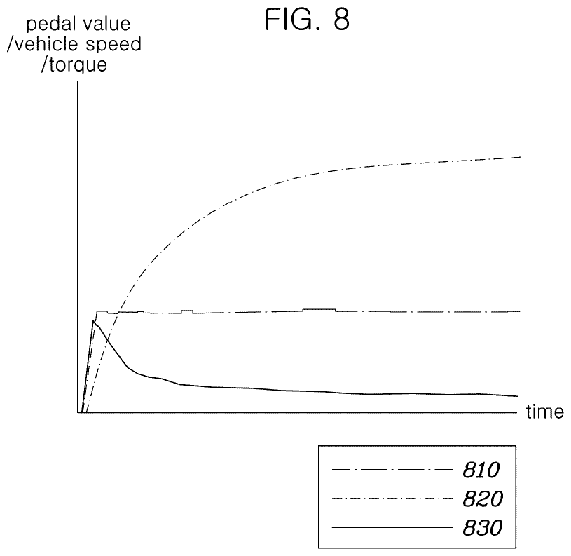

Referring to FIG. 8, a third pedal value graph 810 illustrates the pedal value when the pedal value is adjusted to a third value greater than the second value. A third vehicle speed graph 820 illustrates the vehicle speed when the pedal value is adjusted to the second value greater than the first value. A third torque graph 830 illustrates the torque when the pedal value is adjusted to the second value greater than the first value.

Referring to the first vehicle speed graph 620, in the vehicle speed-based control mode, when the pedal value is maintained at the first value, the required vehicle speed may increase until the required vehicle speed converges s to a constant-speed-maintaining vehicle speed corresponding to the first value. Accordingly, the vehicle speed, which is controlled to follow the target vehicle speed corresponding to the required vehicle speed, may also increase until the vehicle speed converges to the constant-speed-maintaining vehicle speed.

In an embodiment, in a first half range in which the pedal value is adjusted to the first value, the difference between the required vehicle speed and the target vehicle speed is relatively large, such that the magnitude of the target vehicle speed variation may be large, and accordingly, the vehicle speed variation may also be large.

On the other hand, in a second half range in which the difference between the required vehicle speed and the target vehicle speed is small, the difference between the required vehicle speed and the target vehicle speed is relatively small, such that the magnitude of the target vehicle speed variation may be small, and accordingly, the vehicle speed variation may also be small.

Similarly, in the vehicle speed-based control mode, referring to the second vehicle speed graph 720, when the pedal value is maintained at the second value, the vehicle speed may increase until the vehicle speed converges to the constant-speed-maintaining vehicle speed. Further, referring to the third vehicle speed graph 820, when the pedal value is maintained at the third value, the vehicle speed may increase until the vehicle speed converges to the constant-speed-maintaining vehicle speed corresponding to the third value.

In addition, referring to the first torque graph 630, the second torque graph 730, and the third torque graph 830, the torque may be controlled such that the vehicle speed follows the target vehicle speed in the vehicle speed-based control mode, unlike a torque map-based control mode that maintains the torque magnitude corresponding to the pedal value.

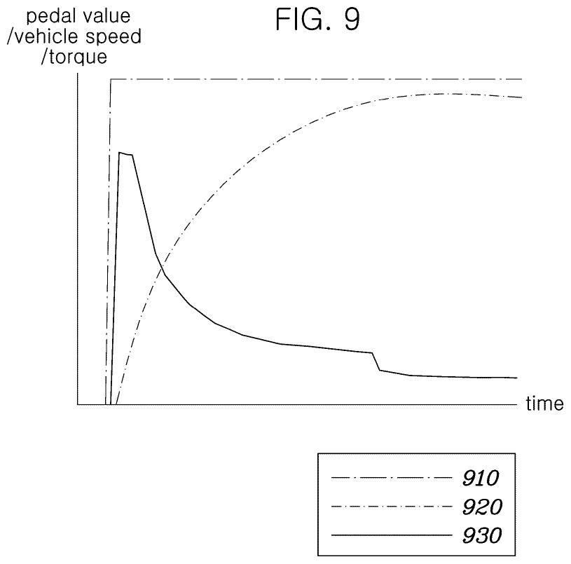

Referring to FIG. 9, a fourth pedal value graph 910 illustrates the pedal value when the pedal value is adjusted to a fourth value, that is a preset upper limit of the pedal value. FIG. 9 also shows a fourth vehicle speed graph 920 and a fourth torque graph 930.

The fourth pedal value graph 910 corresponds to a case in which the pedal value is adjusted to the fourth value that is a preset upper limit of the pedal value.

Referring to the fourth vehicle speed graph 920, the vehicle speed may increase until the vehicle speed converges to a fourth vehicle speed that is the required vehicle speed corresponding to the fourth value. In an embodiment, the required vehicle speed corresponding to the fourth value may be set to correspond to a constant-speed-maintaining vehicle speed, regardless of the vehicle speed. Accordingly, if the pedal value is maintained at the fourth value, that is the upper limit of the preset pedal value, the vehicle speed of the electrified vehicle may be controlled to maintain the fourth vehicle speed, that is the required vehicle speed, after the vehicle speed reaches the fourth vehicle speed.

Referring to the fourth torque graph 930, the torque may be controlled such that the vehicle speed converges to the required vehicle speed in the vehicle speed-based control mode, unlike the torque map-based control mode that maintains the torque magnitude corresponding to the pedal value.

On the other hand, in the vehicle speed-based control mode, when the pedal value is less than or equal to a preset lower limit value (i.e., when it is determined that the accelerator pedal is not operated), instead of controlling the vehicle speed to converge to the required vehicle speed by calculating the required vehicle speed, the target vehicle speed, and the variation of the target vehicle speed until the vehicle speed reaches a minimum vehicle speed as described above, the vehicle may be set to drive based on the coasting mode in which the vehicle coasts.

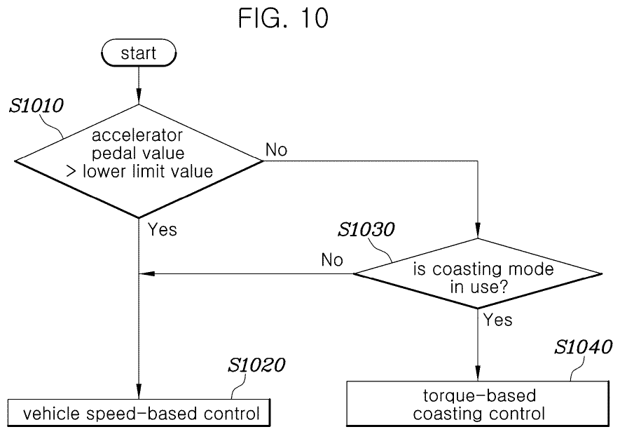

A case where the pedal value is less than or equal to the preset lower limit value in the vehicle speed-based control mode, according to an embodiment, is described in more detail below with reference to FIG. 10.

FIG. 10 is a view illustrating a case in which a coasting mode is selected according to an embodiment.

In an operation S1010, it may be determined whether the accelerator pedal value is greater than a preset lower limit value in the vehicle speed-based control mode. When the accelerator pedal value is greater than a preset lower limit value in the vehicle speed-based control mode (Yes in the operation S1010), the vehicle speed-based control may be performed in an operation S1020 such that the vehicle speed converges to a required vehicle speed corresponding to the accelerator pedal value. For example, if the required vehicle speed is greater than the current vehicle speed of the electrified vehicle, the vehicle speed may increase to converge to the required vehicle speed corresponding to the accelerator pedal value. As another example, if the required vehicle speed is less than the current vehicle speed of the electrified vehicle, the vehicle speed may decrease to converge to the required vehicle speed corresponding to the accelerator pedal value.

When the accelerator pedal value is less than a preset lower limit value in the vehicle speed-based control mode (No in the operation S1010), the driving mode determination unit 33 may determine, in an operation S1030, whether the coasting mode is in use. In an embodiment, the driving mode determination unit 33 whether the coasting mode is in use based on a request to use the coasting mode or a request to stop using the coasting mode, received from the interface unit 20.

Based on a determination that the coasting mode is in use (Yes in the operation S1030), the vehicle speed control unit 36 may, in an operation S1040, perform coasting control of the drive unit 40, such the electrified vehicle coasts. For example, in the coasting mode, torque control may be performed to control the drive unit 40 based on the coasting torque.

On the other hand, based on a determination that the coasting mode is not in use (No in the operation S1030), the vehicle speed control unit 36 may, in an operation S1020, perform the vehicle speed-based control such that the vehicle speed converges to a required vehicle speed corresponding to the accelerator pedal value. For example, when the accelerator pedal value is less than the preset lower limit, control may be performed such that the required vehicle speed converges to a preset minimum vehicle speed based on the required vehicle speed map, the target vehicle speed map, and the target vehicle speed variation map.

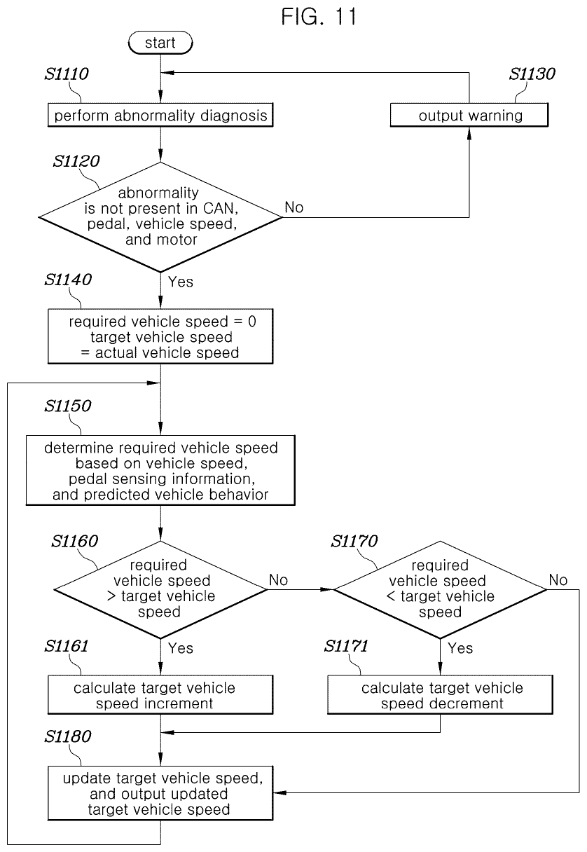

FIG. 11 is a flowchart illustrating a control method of the electrified vehicle according to an embodiment.

Referring to FIG. 11, in an operation S1110, the diagnosis unit 32 may perform an abnormality diagnosis to determine, in an operation S11220, whether abnormality is not present in the CAN, pedal, vehicle speed, and motor.

Based on determining that abnormality is present (No in the operation S1120), the diagnosis unit 32 may transmit a warning output request to the interface unit 20, such that the interface unit 20 may output a warning in an operation S1130.

Based on determining that abnormality is not present (Yes in the operation S1120), the required vehicle speed determination unit 34 may, in an operation S1140, set an initial value of the required vehicle speed to 0. Further, in the operation S1140, the target vehicle speed determination unit 35 may set an initial value of the target vehicle speed to the actual vehicle speed. However, the initial values of the required vehicle speed and the target vehicle speed described above are illustrative, and the present disclosure is not limited thereto. For example, the initial values of the required vehicle speed and the target vehicle speed may be set to 0 or to a value other than the actual vehicle speed of the electrified vehicle, respectively, in some embodiments.

In an operation S1150, the required vehicle speed determination unit 34 may determine the required vehicle speed based on the vehicle speed, the pedal sensing information, and the predicted vehicle behavior. For example, when the predicted vehicle behavior received from the vehicle behavior prediction unit 31 is not in a collision warning state, the required vehicle speed determination unit 34 may determine a required vehicle speed corresponding to the pedal sensing information and the vehicle speed based on the required vehicle speed map.

In addition, if the required vehicle speed is greater than the target vehicle speed (Yes in an operation S1160), the target vehicle speed determination unit 35 may calculate the target vehicle speed increment in an operation S1161, may update the target vehicle speed, and output the updated target vehicle speed, in an operation S1180. In this case, in an embodiment, the target vehicle speed may be updated as the sum of the target vehicle speed and the target vehicle speed increment based on the target vehicle speed variation determined by the target vehicle speed determination unit 35.

In addition, if the required vehicle speed is less than the target vehicle speed (Yes in an operation S1170), the target vehicle speed determination unit 35 may calculate the target vehicle speed decrement in an operation S1171, and may update the target vehicle speed and output the updated target vehicle speed in the operation S1180. In this case, in an embodiment, the target vehicle speed may be updated as the sum of the target vehicle speed and the target vehicle speed decrement based on the target vehicle speed variation determined by the target vehicle speed determination unit 35.

In an embodiment, if the required vehicle speed is equal to the target vehicle speed (No in the operation S1170), the target vehicle speed determination unit 35 may update the target vehicle speed to maintain the same value and output the updated target vehicle speed in the operation S1180.

The electrified vehicle and the control method thereof according to embodiments of the present disclosure may perform vehicle speed control based on a required vehicle speed corresponding to accelerator pedal operation.

In addition, the electrified vehicle and the control method thereof according to embodiments may reduce a vehicle speed variation caused by the influence of environmental factors such as a gradient change in a driving road, vehicle weight, and driving resistance, as compared to the torque map-based control.

In addition, the electrified vehicle and the control method thereof according to embodiments may minimize real vehicle testing, since the vehicle speed may follow the required vehicle speed within the speed follow-up performance of a control unit.

In addition, the electrified vehicle and the control method thereof according to embodiments may output, to the interface, information indicating that the vehicle speed is limited when the pedal value reaches an upper limit value.

In addition, the electrified vehicle and the control method thereof according to embodiments may enable intuitive profile setting based on the vehicle speed in a profile setting mode.

Although certain embodiments of the present disclosure have been illustrated and described, it should be apparent to those having ordinary skill in the art to which the present disclosure pertains that various modifications and changes to the present disclosure may be made without departing from the technical spirit of the present disclosure provided in the following claims.

What is claimed is:

1. An electrified vehicle comprising:
a controller configured to:
determine a required vehicle speed corresponding to accelerator pedal sensing information;
determine a target vehicle speed to reach the required vehicle speed based on a vehicle speed;
determine a variation of the target vehicle speed based on the required vehicle speed and the target vehicle speed; and
control a torque of a drive motor such that the vehicle speed follows a target vehicle speed taking the variation into account.

2. The electrified vehicle of claim 1, wherein the controller is configured to determine the required vehicle speed further based on the vehicle speed.

3. The electrified vehicle of claim 1, wherein the controller is configured to determine the required vehicle speed based on a required vehicle speed map in which the required vehicle speed corresponding to the accelerator pedal sensing information is predefined as a function of the vehicle speed.

4. The electrified vehicle of claim 3, wherein the required vehicle speed map is set such that the required vehicle speed varies to converge toward a preset constant-speed-maintaining vehicle speed based on the accelerator pedal sensing information.

5. The electrified vehicle of claim 1, wherein the controller is configured to determine the variation based on a target vehicle speed variation map in which the variation is preset corresponding to the required vehicle speed and a difference between the required vehicle speed and the target vehicle speed.

6. The electrified vehicle of claim 5, wherein the target vehicle speed variation map is set such that the variation is proportional to a magnitude of a difference between the target vehicle speed from the required vehicle speed.

7. The electrified vehicle of claim 1, wherein the controller is configured to:
determine an initial value of the target vehicle speed based on the vehicle speed;
determine a sum of the variation and the target vehicle speed; and
update the target vehicle speed based on the sum of the variation and the target vehicle speed.

8. The electrified vehicle of claim 1, wherein the controller is configured to:
determine a target torque based on the variation corresponding to the required vehicle speed and the target vehicle speed, road gradient information, and driving resistance information; and
control the torque of the drive motor to follow the target torque.

9. The electrified vehicle of claim 1, wherein the controller is configured to control the torque of the drive motor in a coasting mode that causes the electrified vehicle to coast, based on a determination that a pedal value is less than or equal to a preset lower limit value, wherein the pedal value corresponds to a degree of operation of an accelerator pedal determined based on the accelerator pedal sensing information.

10. The electrified vehicle of claim 1, further comprising an interface configured to receive input on whether to use a coasting mode that causes the electrified vehicle to coast.

11. A control method of an electrified vehicle, the control method comprising:
determining, by a controller, a required vehicle speed corresponding to accelerator pedal sensing information;
determining, by the controller, a target vehicle speed to reach the required vehicle speed based on a vehicle speed of the electrified vehicle;
determining, by the controller, a variation of the target vehicle speed based on the required vehicle speed and the target vehicle speed; and
controlling, by the controller, torque of a drive motor such that the vehicle speed follows a target vehicle speed taking the variation into account.

12. The control method of claim 11, wherein determining the required vehicle speed includes determining the required vehicle speed further based on the vehicle speed.

13. The control method of claim 11, wherein determining the required vehicle speed includes determining the required vehicle speed based on a required vehicle speed map in which the required vehicle speed corresponding to the accelerator pedal sensing information is predefined as a function of the vehicle speed.

14. The control method of claim 13, wherein the required vehicle speed map is set such that the required vehicle speed varies to converge toward a preset constant-speed-maintaining vehicle speed based on the accelerator pedal sensing information.

15. The control method of claim 11, wherein determining the variation includes determining the variation based on a target vehicle speed variation map in which the variation is preset corresponding to the required vehicle speed and a difference between the required vehicle speed and the target vehicle speed.

16. The control method of claim 15, wherein the target vehicle speed variation map is set such that the variation is proportional to a magnitude of a difference between the target vehicle speed from the required vehicle speed.

17. The control method of claim 11, further comprising:
determining, by the controller, an initial value of the target vehicle speed based on the vehicle speed; and
updating the target vehicle speed based on a sum of the variation and the target vehicle speed.

18. The control method of claim 11, wherein controlling torque of a drive motor comprises:
determining, by the controller, a target torque based on a variation corresponding to the required vehicle speed and the target vehicle speed, road gradient information, and driving resistance information; and
controlling, by the controller, the torque of the drive motor to follow the target torque.

19. The control method of claim 11, further comprising controlling, by the controller, the torque of the drive motor based on a coasting mode that causes the electrified vehicle to coast, based on a determination that a pedal value is less than or equal to a preset lower limit value, wherein the pedal value corresponds to a degree of operation of an accelerator pedal determined based on the accelerator pedal sensing information.

20. The control method of claim 11, further comprising receiving, by an interface, input on whether to use a coasting mode that causes the electrified vehicle to coast.
